(19) United States
(12) Patent Application Publication
(10) Pub. No.: US 2003/0116030 A1
(43) Pub. Date: Jun. 26, 2003

(54) Oven heating with the lightwave

(76) Inventor: Donglei Wang, Zhuhai (CN)

Correspondence Address: KNOBBE MARTENS OLSON & BEAR LLP, 2040 MAIN STREET, FOURTEENTH FLOOR, IRVINE, CA, 92614, US

(21) Appl. No.: 10/309,396

(22) Filed: Dec. 3, 2002

(30) Foreign Application Priority Data
Dec. 13, 2001 (CN) 01258683.8

(51) Int. Cl. A23L 1/00

(52) U.S. Cl. 99/340; 99/339

(57) ABSTRACT

An oven for cooking a food item containing a halogen lamp and an infrared tube.

### RELATED APPLICATION

The present application is based on and claims priority under 35 U.S.C. §119 to Chinese Patent Application No. 01258683.8, filed Dec. 13, 2001, the disclosure of which is hereby incorporated by reference in its entirety.

### BACKGROUND OF THE INVENTION

1. Field of the Invention

This invention generally relates to an oven, and more particularly an oven that uses a light source for generating heat.

2. Description of the Related Art

Conventional ovens are generally heated using heating elements such as electronic heating tubes or quartz tube. Such heating elements generate heat via a resistive wire surrounded by an insulting material such as magnesia powder or quartz. The heat energy transmission and exchange procedure is from the heating element (wire) to the insulator, from the insulator to the air environment, and from the air environment to the food.

This exchange process is relatively slow, which is not good for the retaining of the water and fresh component inside the food, thus degrading the quality of the food item due to the loss of the vitamin and other nutrients. In addition, the electronic heating tube easily absorbs moisture and erodes, which leads to the degradation of the insulation performance and affects the lifetime of the oven. Subsequently, the halogen lamp is adopted as the light source for baking food, which could overcome some of the above shortcoming related to the electronic heating tube, but since it is complicated in the structure and the less choice of the light source, it is not widely developed.

### SUMMARY OF THE INVENTION

An object of the present invention is to provide an oven that uses a halogen lamp as the main heating element and an infrared tube or quartz tube as a supplementary heating element. The halogen lamp produces light into the far infrared waveband of the electromagnetic spectrum that is used as the main energy source for cooking the food item. Optical energy from the halogen lamp is directly transmitted to the food item, thus reducing the cooking time, which satisfies the user's desire for a higher life quality and quicker life style.

In certain embodiments, the oven includes a case, a halogen tube, a glass door, a light prohibiting cover, an inner liner, an infrared tube, a protecting hood, wherein the halogen tube and infrared tube for heating are disposed inside an oven chamber. The inner liner is disposed between the case and the halogen tube.

In certain embodiments, a halogen tube and an infrared tube are disposed according to the shape of the chamber. The halogen tube is disposed at the top of the inner chamber of the case and the inner liner is formed between the case and the halogen tube. The infrared tube is disposed at the bottom of the inner chamber of the case and the protecting hood is installed above the infrared tube.

An oven according to embodiments of the present invention has the following advantages:

A. Higher efficiency and faster cooking of a food item.

B. More nourishment and better tasting baked food.

C. The halogen tube is easily repaired and replaced without the need of taking apart the oven.

D. The food is visible during the operation without the need for additional lighting.

### BRIEF DESCRIPTION OF THE DRAWINGS

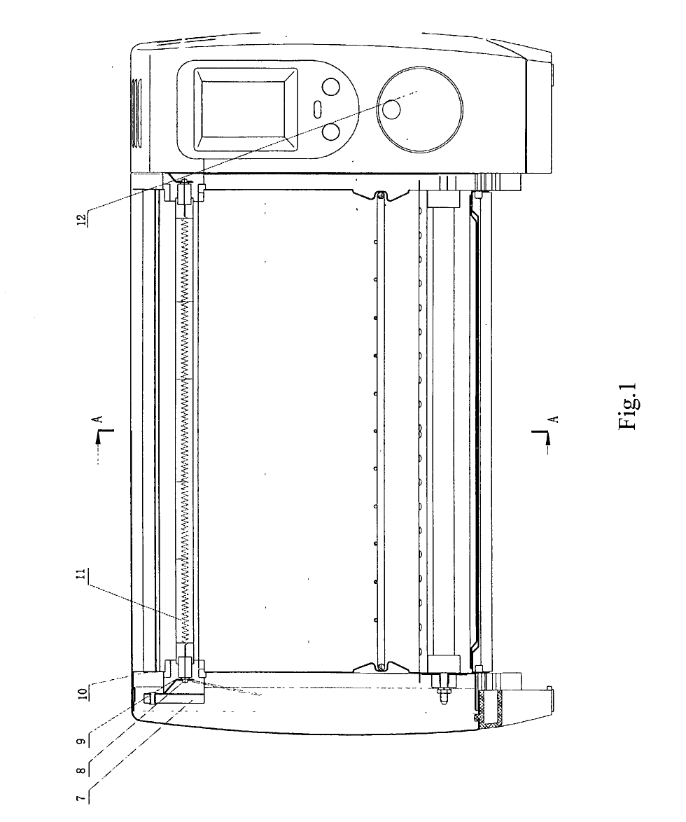

The FIG. 1 shows a front schematic view of the oven according to this utility model showing: 7—halogen ceramic 8—contact point; 9—elastic plate; 10—left panel; 11—halogen tube; 12—button;

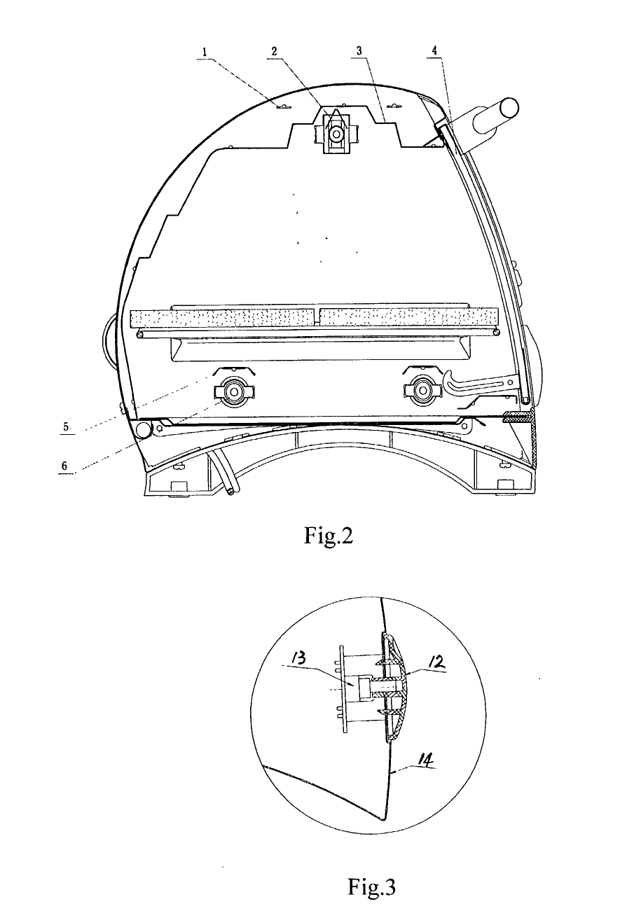

The FIG. 2 shows a cross-section view along the A-A of the FIG. 1 and additionally shows: 1—right panel; 2—light prohibiting hood; 3—inner liner; 4—door glass; 5—protecting cover; 6—infrared tube (quartz tube);

The FIG. 3 shows a structural view of the button of this utility model and additionally shows: 13—controller; 14—case.

### DETAILED DESCRIPTION OF THE PREFERRED EMBODIMENT

In certain embodiments, as illustrated in FIGS. 1 and 2, an oven comprises a case (1,10), a halogen tube 11, a door glass 4, a light prohibiting hood 2, an inner liner 3, an infrared tube 6 and a protecting cover 5. The halogen tube 11 is disposed at the top of the inner chamber of the case (1,10) and the light prohibiting hood 2 is installed above the halogen tube 11. The inner liner 3 is formed between the case (1,10) and the halogen tube 11. The infrared tube 6 is disposed at the bottom of the inner chamber of the case (1,10) and the protecting hood 5 is installed above the infrared tube 6. The inner liner 3 is made from the stainless steel and is bent along a contour line of the case (1,10). The glass door 4 is made from a net shape screen print glass in dark color or film plating glass. In certain embodiments, the halogen lamp 11 is elongated and is transversely disposed between the right panel 1 and the left panel 10.

In certain embodiments, the halogen tube 12, disposed in the upper part of the oven, utilizes high power and is the main heating source. The infrared tube (quartz tube) 6 is used for supplemental heating in the lower part of the oven. Uniformity of the radiation is adjusted by reflection of energy off of the inner liner3, the door glass 4, the left panel 10 and right panel 1 together with the light prohibiting hood 1 and protecting cover 5. This arrangement helps to provide uniform baking of the food item. The foldable inner liner 3 made from stainless steel, which scatters radiation at different angles. The door glass 4 may be in the form of dark toughened glass together with a screen print glass or the film plating glass for sheltering from and reflecting light energy.

In certain embodiments, the baking temperature and the operation time of the oven are controlled in electric and mechanical ways, and preferably the oven is operated using a one figure regulating component, such as a freely rotatable button 12. As shown in FIG. 3, the button 12 may be disposed on a case 14, wherein the button 12 is connected with the controller 13 within the case 14.

What is claimed is:

1. An oven for cooking a food item comprising a halogen lamp and an infrared tube.

2. The oven according to claim 1, wherein the infrared tube comprises a quartz tube.

3. The oven according to claim 1, wherein the infrared tube comprises an electronic heating tube.

4. The oven according to claim 1, further comprising an enclosure comprising a top and a bottom, wherein the halogen lamp and the infrared tube are disposed inside the enclosure so as to direct radiant energy towards the center of the enclosure.

5. The oven according to claim 4, wherein the halogen lamp is disposed near the top of the enclosure and the infrared tube are disposed near the bottom of the enclosure.

6. The oven according to claim 4, wherein the enclosure comprises:
a left panel and a right panel disposed on opposite ends of the enclosure;
an inner liner disposed between the left panel and the right panel; and
a door disposed between the left panel and the right panel;

7. The oven according to claim 6, wherein the halogen lamp has a light prohibiting hood disposed along at least a portion thereof.

8. The oven according to claim 6, wherein the infrared tube has a protecting hood disposed along at least a portion thereof.

9. The oven according to claim 6, wherein:
the left panel and the right panel have contour lines;
the inner liner is formed along the contour lines.

10. The oven according to claim 6, wherein the inner liner comprises stainless steel.

11. The oven according to claim 6, wherein the door comprises a net shape screen print glass of a dark color.

12. The oven according to claim 6, wherein the door is made from a film plating glass.

13. The oven according to claim 6, further comprising a button disposed on one of the panels, wherein the button is operated with one figure tip and controls the temperature of the oven.

14. The oven according to claim 6, the halogen lamp is transversely disposed between the left panel and the right panel.

15. An oven for cooking a food item comprising a halogen lamp and an infrared tube.

16. A method of cooking a food item comprising:
providing an oven comprising a halogen lamp and an infrared tube;
placing a food item in said oven and heating said food item.
